(19) United States
(12) Patent Application Publication
(10) Pub. No.: US 2012/0203575 A1
(43) Pub. Date: Aug. 9, 2012

(54) MEDICAL INFORMATION SYSTEM

(75) Inventors: Paola Karina Tulipano, Englewood, NJ (US); Yuechen Qian, Eindhoven (NL); Merlijn Sevenster, Eindhoven (NL); Dieter Geller, Aachen (DE)

(73) Assignee: KONINKLIJKE PHILIPS ELECTRONICS N.V., EINDHOVEN (NL)

(21) Appl. No.: 13/498,503

(22) PCT Filed: Aug. 19, 2010
(86) PCT No.: PCT/IB2010/053757

§ 371 Date: Apr. 24, 2012

Related U.S. Application Data
(60) Provisional application No. 61/246,254, filed on Sep. 28, 2009.

(51) Int. Cl. G06Q 50/24

(52) U.S. Cl. 705/3

(57) ABSTRACT

A medical information system (170) comprising a validator (140) configured to validate image findings, which are generated based on an image of anatomical structures produced by an imaging apparatus (110), in a first report with at least one of a set of predefined templates or processed data generated based on the set of predefined templates, and an augmenter (160) configured to augment the first report with information from a second report that includes medical findings.

The following relates to managing medical information, and more particularly, to validating and/or augmenting medical information in medical reports.

With advances in imaging acquisition technology, there is an overwhelming amount of imaging data acquired on a daily basis. Radiologists have to manually review numerous images. As a consequence, there is likelihood a radiologist may overlook information in an image that is relevant to diagnosing and treating a medical condition. Once the radiologist has read the images for a patient, the radiologist dictates the findings, and the findings are subsequently used to generate a radiology report.

Pathology and other diagnostic results are also an important part of reading images. For example, the selection of additional or follow-up imaging and non-imaging studies, interpretations of the images, and patient treatments may be dependent upon the pathology results. In clinical practice, the radiology results may remain inconclusive until pathology results are obtained.

In order to improve diagnostic accuracy of radiology results, it's essential to correlate specific imaging findings to pathological findings in radiological research. Unfortunately, this may require the radiologist to manually retrieve the pathology report or other diagnostic results. This process may be time consuming and error prone.

After a radiologist dictates findings with an inconclusive diagnosis, the radiologist will move on to the next set of images for a different patient, and later returns to the report with the inconclusive diagnosis one or more times to update the report based on the pathology report and/or other report.

In the clinical workflow, the addition of pathology data to the radiology report may also assist the referring physician by reducing ambiguity and uncertainty of radiology report results.

Aspects of the application address the above matters, and others.

According to an aspect of the invention, a medical information system (170) comprises a validator (140) configured to validate image findings, which are generated based on an image of anatomical structures produced by an imaging apparatus (110), in a first report with at least one of a set of predefined templates or processed data generated based on the set of predefined templates, and an augmenter (160) configured to augment the first report with information from a second report that includes medical findings.

According to another aspect of the invention, a computer readable medium having computer executable instructions stored thereon, which instructions, when executed by a processor, performs a method, the method comprising: validating findings in a first report with at least one of a set of predefined templates or processed data generated based on the set of predefined templates, and augmenting the first report with information from a second report generated with medical findings.

According to another aspect of the invention, a medical information system (170) comprises a validator (140) configured to validate image findings based on an image of anatomical structures generated by an imaging apparatus (110) in a first report with at least one of a set of predefined templates or processed data generated based on the set of predefined templates.

According to another aspect of the invention, a medical information system (170) comprises an augmenter (160) configured to augment a first report that includes image findings based on an image of anatomical structures generated by an imaging apparatus (110) with information from a second report that includes medical findings.

The aspects defined above and further aspects of the invention are apparent from the examples of embodiment to be described hereinafter and are explained with reference to the examples of embodiment.

The invention will be described in more detail hereinafter with reference to examples of embodiment but to which the invention is not limited.

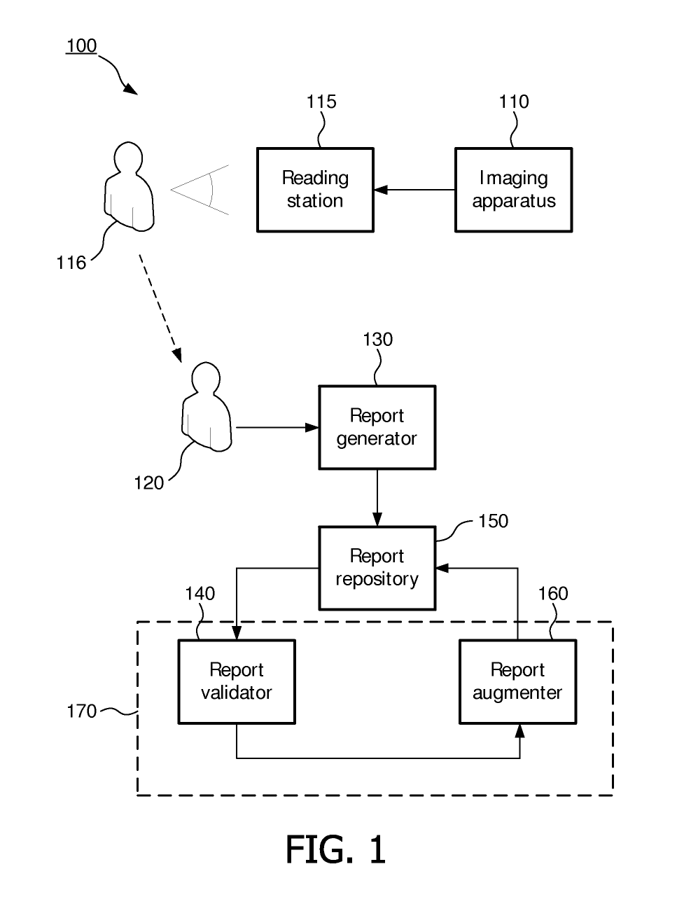

FIG. 1 illustrates a block diagram of a medical information system.

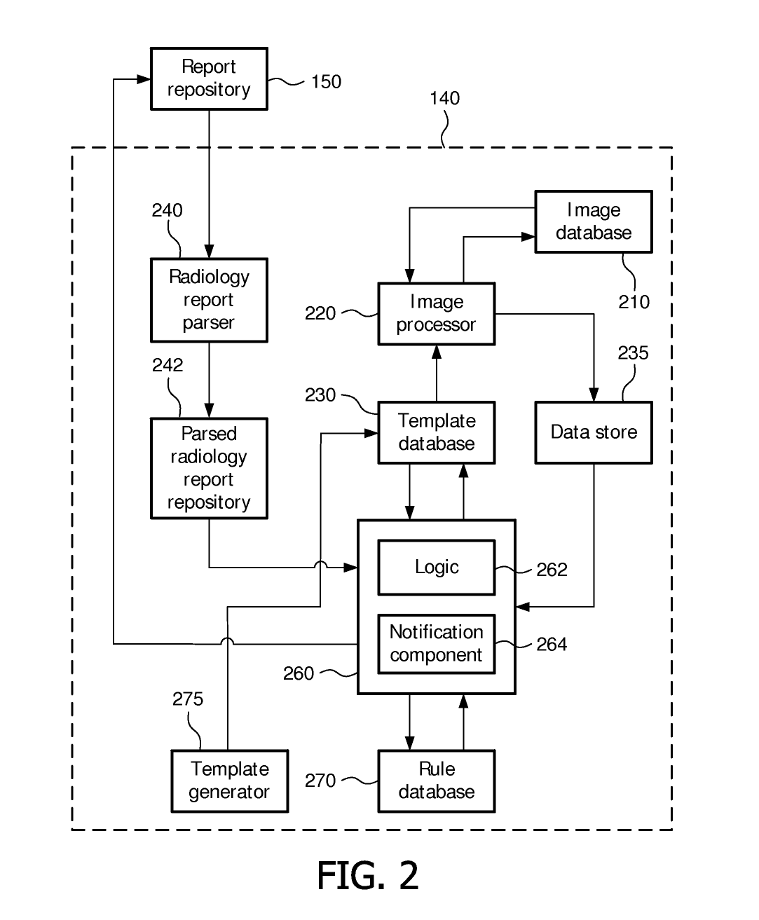

FIG. 2 illustrates a block diagram of a system for the validation of radiology reports.

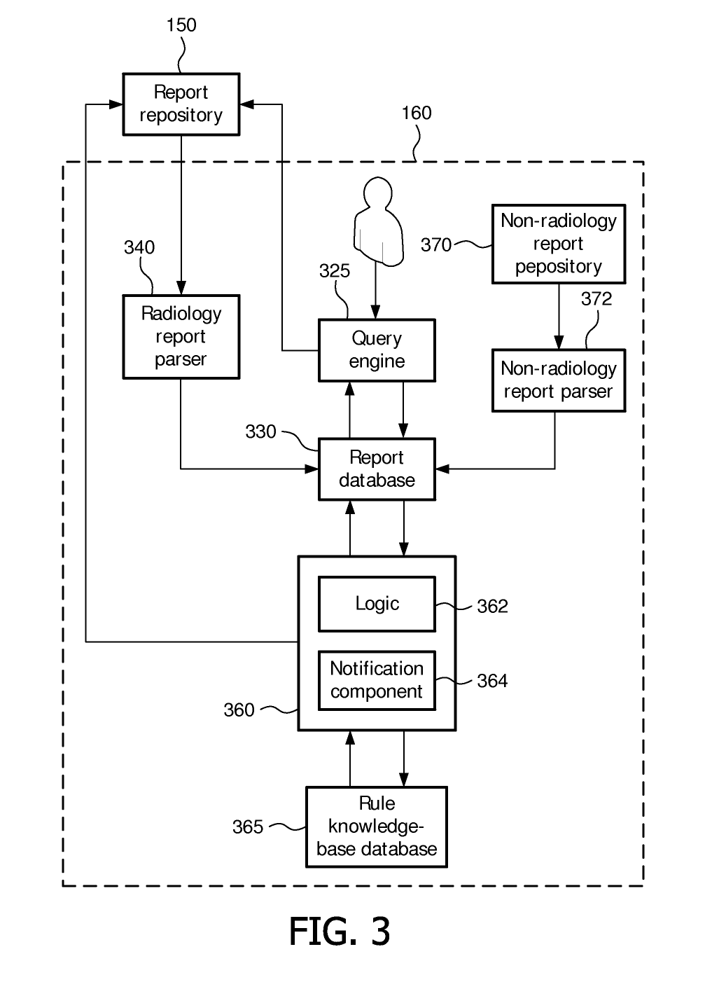

FIG. 3 illustrates a block diagram of a system for the augmentation of radiology reports.

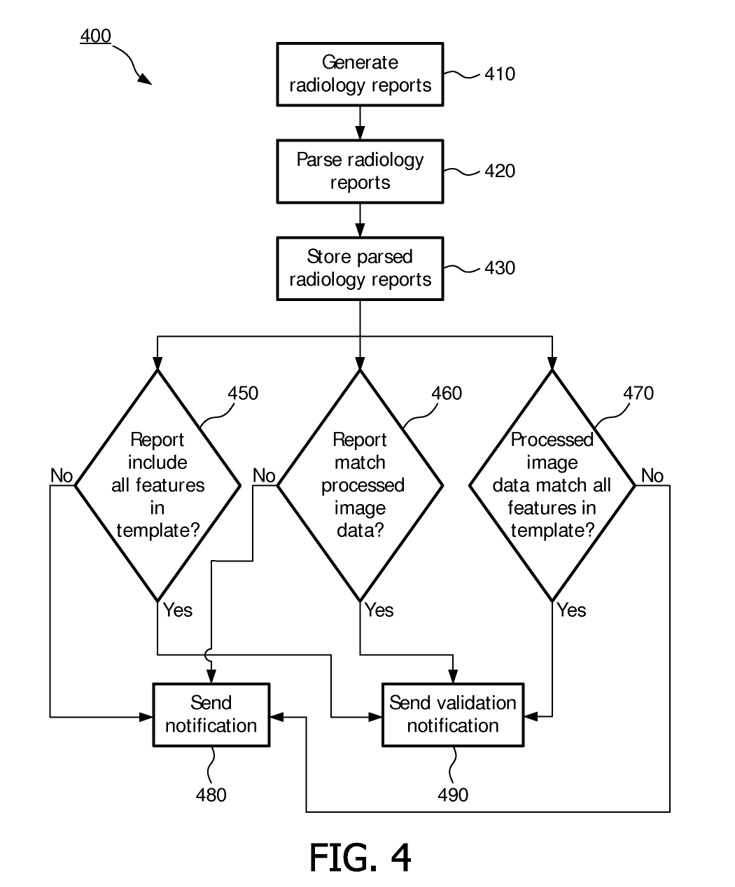

FIG. 4 illustrates a flow diagram of a method for validating radiology reports.

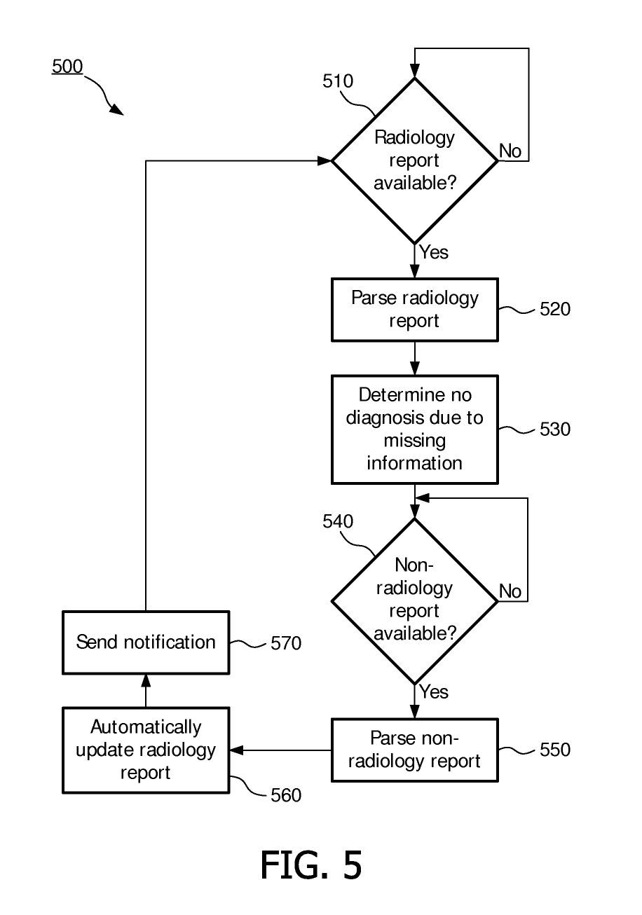

FIG. 5 illustrates a flow diagram of a method for the augmentation of radiology reports.

With reference to FIG. 1, a system (100) includes an imaging apparatus 110 that produces imaging data used to generate one or more images of anatomical structure of a patient, and the images may be displayed via a monitor and/or film. The imaging apparatus 110 is for example an X-ray, computed tomography (CT), magnetic resonance imaging (MRI), single photon emission tomography (SPECT), positron emission tomography (PET) and ultrasound imaging (US) imaging apparatus.

A reading station 115 is used to read films or view images on a monitor. The radiologist 116 reviews the images from the films or monitor and dictates findings into a recording device. A transcriptionist 120 uses a report generator 130 such as word processing software running on a computing system like a personal computer or the like to generate a radiology report with the dictated findings.

An electronic report repository 150 such as a database, server, etc., stores the radiology reports with the dictated findings.

An optional report validator 140 validates the information in the reports. As described in greater detail below, the report validator 140 validates findings in the report based on a set of predefined templates and/or processed data generated based on the set of predefined templates.

An optional report augmenter 160 augments a report with relevant information after a report is generated and stored in the repository 150. As described below, such additional information includes information from reports generated by non-imaging departments, such as a pathology department, a laboratory department, and/or other department, and/or another imaging report.

The illustrated report validator 140 and the report augmenter 160 are part of a medical information system 170 and can be implemented thereby via one or more processors executing one or more instructions stored in computer readable medium.

Referring now to FIG. 2, an exemplary report validator 140 is illustrated and includes the following exemplary elements and element interactions.

The report validator 140 includes a radiology report parser (analyzer) 240 which parses radiology reports and extracts or obtains medical findings, which are stored in a parsed radiology report repository 242. The extracted findings may be stored in the same or a different format as the radiology reports. The radiology report parser 240 may include a natural language processing (NLP) engine or module that extracts the relevant findings from the radiology reports. An example of such a NLP module includes a Medical Language Extraction and Encoding System (MEDLEE) module, which extracts the textual findings in the radiology reports and encodes them into a data format that may be processed as described in more detail below.

A template database 230 stores a set of predefined templates of generalized report features. A template generator 275 is optionally provided to generate the set of predefined templates based on extracted report features from previously generated radiology reports and features in images. For example, previously generated radiology reports for brain scans for vertigo typically identify five locations of the brain. This information can be stored in a predefined template for brain scans for vertigo. The templates in template database 230 may be updated with findings as reports are generated.

An image processor 220 processes images in image database 210 (which include the images used to generate the reports) and generates information or data indicative thereof. The images are optionally segmented based on a predefined template in the template database 230. The information or data generated by the image processor 220 can include image data and/or an image generated from the image data. The processed data and/or segmented image are stored in a data store 235. The processed data may be stored in various formats, for example, in the format of the native format of the software used to create the reports.

A computing system 260 having logic 262 matches the findings in the parsed radiology reports, the features in the set of predefined templates stored in the template database 230 and/or the processed data in the data store 230. In one instance, matching means comparing the findings in the parsed radiology reports with the related features in the set of predefined templates stored in the template database 230 and/or processed data in the data store 230 to determine if there is a discrepancy. The logic 262 includes first logic which uses rules from a rule database 270 to determine whether there is a discrepancy.

The logic 262 also includes second logic which uses multiple rules from the rule database 270 that include guidelines for determining recommended actions to be taken depending on the results of matching or not matching the findings in the parsed radiology reports with the related features in the set of predefined templates stored in the template database 230 and/or processed data in the data store 230.

For example, the rule database 270 may contain a rule that if no discrepancies are found between the findings in the radiology report and the generalized report features in the set of predefined templates, a notification component 264 of the computing system 260 sends a notification to the radiologist indicating that there are no discrepancies. Another rule in the rule database 270 may invoke the notification component 264 to send a notification to the radiologist indicating that there are no discrepancies between the relevant findings in the radiology report and the processed data. The notification may be an alert, e-mail with normal or urgent priorities, regular mail or other notification means.

Another rule in the rule database 270 may invoke the notification component 264 to send a notification to the radiologist indicating that there is a discrepancy between the findings in a radiology report and the processed data. For example, the findings in the radiology report for a brain scan for vertigo may be that there are four spots on the brain. The processed data for the image may indicate that there are five spots on the brain. The radiologist may validate the discrepancy and augment the radiology report, note the discrepancy, order further testing, and/or request that another radiologist or the referring physician review the images. Alternatively, the logic 262 may automatically augment the radiology report with the information from the processed data, and the notification component 264 will send a notification to the radiologist indicating that the report has been augmented.

Another rule in rule database 270 may instruct the logic 262 to try to reconcile a discrepancy between the processed data and findings not reported on in the radiology report. For example, the processed data may indicate that the correlating images show five spots on the brain but nothing is noted about the spots in the radiology report. In accordance with the rule, the logic 262 may attempt to reconcile that the five spots on the brain indicate vertigo based on the history of typical findings for brain scans of vertigo in the set of predefined templates. The notification component 264 will send a notification to the radiologist indicative of the discrepancy. The radiologist will validate the discrepancy and augment the radiology report, reject it, order additional testing, or request another radiologist or the referring physician to review the images. Alternatively, the logic 262 may automatically augment the radiology report with the information from the processed data that there are five spots on the brain, and send a notification to the radiologist indicating that the report has been augmented.

As another example of the foregoing, a frequently noted feature in neuroradiology reports is whether or not “midline shift” exists within the image. Midline shift is often associated with high intracranial pressure which may be deadly. The radiologist will note in the neuroradiology reports “No shift of midline structures or other signs of positive mass are noted.” If this feature does exist in the actual image as determined by the image processor 220 and the radiologist has not noted it in the radiology report, logic component 262 will identify the discrepancy using a rule from rule database 270 and perform an action according to a rule in rule database 270 based on the discrepancy.

While the foregoing description provides some examples of different rules in the rule database 270, these are only examples and a variety of other rules are contemplated herein as well, which would be understood by one having ordinary skill in the art.

Although the report was discussed above in the radiology context, other reports from other departments are contemplated herein.

Referring now to FIG. 3, an exemplary report augmenter 160 is illustrated with the following exemplary elements and element interactions.

A radiology report parser (analyzer) 340 parses the radiology reports from the report repository 150 to extract or obtain medical findings, which are stored in a report database 330 in XML or other formats. The radiology report parser 340 may include a natural language processing (NLP) engine or module that extracts the relevant findings from the radiology reports, such as for example a Medical Language Extraction and Encoding System (MEDLEE) module, which extracts the textual findings in the radiology reports and encodes them into a data format that may be processed as described in detail below. Ontologies like Systematized Nomenclature of Medicine—Clinical Terms (SNOMED CT) and RADLEX are used to identify terms in the radiology report such as anatomies.

A non-radiology report repository 370 stores non-radiology reports, such as for example pathology reports in this exemplary illustration.

A non-radiology report parser (analyzer) 372 parses the pathology reports and extracts or obtains medical findings, which are stored in the report database 330. The extracted findings may be stored in the same or a different format as the pathology reports stored in the non-radiology report repository 370. An example of a suitable format is the an XML format.

The non-radiology report parser 372 may include a natural language processing (NLP) engine or module such as a Medical Language Extraction and Encoding System (MEDLEE) module, which extracts the textual findings in the pathology reports and encodes them into a data format that may be processed as described in detail below. Ontologies like Systematized Nomenclature of Medicine—Clinical Terms (SNOMED CT) and RADLEX are used to identify terms in the radiology report such as anatomies. For pathology, a combination of SNOMED and other ontologies such as Gene Ontology may be needed to identify receptors such as the HER-2/Neu receptor.

A computing system 360 includes logic 362 that determines when a parsed radiology report stored in report database 330 is inconclusive about a particular medical finding and when there is a related pathology report with pathology data available. The logic 362 also determines whether the radiology report has been previously updated, and if so, ensures that the radiology report is updated with the most recent pathology report.

If the radiology report has not been previously updated with pathology data, the logic 362 matches the findings in the radiology report with pathology data in the pathology report using rules from a rule knowledge-base database 365. The rule knowledge-base database 365 may include multiple rules that include guidelines for mapping findings in the radiology report with the pathology data in the pathology report.

For example, the logic 362 may execute a rule that determines whether findings in the radiology report are inconclusive about cancer in breast tissue and that the radiology report needs to be augmented with pathology data. Specifically, the rule may invoke the logic 362 to determine if the radiology report is inconclusive about the presence of the HER-2/Neu receptor, which is typically present in breast cancer. The Human Epidermal growth factor Receptor 2 is a protein giving higher aggressiveness in breast cancers. A pathology report for a biopsy of breast tissue may contain the expression “No HER-2/Nue over expression is identified” indicating a negative result for the protein. Alternately, the pathology report may contain the expression “HER-2/Nue over expression is identified” indicating a positive result.

The computing system 360 may include a notification component 364 that structures the output of the logic 362 into the format of the radiology report. For example, a HER2/Neu receptor with a negative result as determined by the logic 362 is structured for the radiology report with appropriate language in the format of the radiology report [“Pathology findings show ‘HER2/Neu’”][negative]. The logic 362 may execute a rule which results in the notification component 364 sending a notification to the radiologist indicating that the radiology report has been augmented. The notification may be an alert, e-mail with normal and urgent priorities, regular mail or other notification means.

Alternatively, the logic 362 may execute a rule invoking the notification component 364 to send a notification to the radiologist indicating that the radiologist should validate the radiology report and the pathology data from the pathology report, reject it, or refer the matter to another radiologist or the referring physician for further analysis.

The logic 362 may execute a rule determining whether the findings in the radiology report match findings in a treatment plan stored in the rule knowledge-base database 365 to evaluate whether the treatment plan is effective. For example, if the radiology report indicates that the HER2/Neu receptor is present in the tissue sample, the logic 362 may evaluate whether the size of the tumor has decreased in accordance with the treatment plan. The notification component 364 may structure the output of the logic 362 into the format of the radiology report and may augment the radiology report with this additional data. The logic 362 may execute a rule invoking the notification component 364 to send a notification to the radiologist indicating that the radiology report has been augmented with this information.

In an alternate embodiment, the logic 362 may execute a rule invoking the notification component 364 to send a notification to the radiologist indicating that the radiologist should validate the radiology report with the augmented pathology and treatment data, reject it, or refer the matter to another radiologist or the referring physician for further analysis.

The logic 362 may then process the next parsed radiology report with inconclusive findings.

In the illustrated embodiment, the report augmenter 160 includes a query engine 325 that allows a clinician, radiologist, or the referring physician to query whether pathology, diagnostic or treatment data is available for one or more of the radiology reports and whether the radiology reports have been augmented with this information. The query engine 325 may be a web-based application in communication with the report database 330 over a global computer network or a console-based application in communication with the report database 330 over a computer local area network or other computer network.

Referring to FIG. 4, illustrated is an example method 400. It is to be appreciated that the ordering of the acts is not limiting. As such, one or more of the acts may occur in a different order, including concurrently with one or more other acts. In addition, one or more of the acts can be omitted and/or one or more other acts can be added.

At 410, one or more electronic radiology reports are generated.

At 420, the radiology reports are parsed to extract findings from the reports.

At 430, the extracted information is stored in a report repository.

At 450, it is determined whether there are any discrepancies between the extracted information from the radiology report and generalized report features in a set of predefined templates.

If there are no discrepancies, then at 480 a notification is sent to the radiologist indicating that there are no discrepancies between the extracted information from the radiology report and all of the features in the set of predefined templates.

If there are discrepancies, then at 490 a notification is sent to the radiologist indicating that the radiologist should validate the discrepancies between the extracted information from the radiology report and the features in the set of predefined templates and/or augment the report.

At 460, it is determined whether there are any discrepancies between the extracted information from the radiology report and the processed data generated based on the set of templates.

If there are no discrepancies, then at 480 a notification is sent to the radiologist indicating that there are no discrepancies between the extracted findings in the radiology report and the features in the set of predefined templates.

If there are discrepancies, then at 490 a notification is sent to the radiologist indicating that the radiologist should validate the discrepancies between the extracted information from the radiology report and the features in the set of predefined templates and/or augment the report.

At 470, it is determined whether there are any discrepancies between the processed data and the report features in the set of predefined templates.

If there are no discrepancies, then at 480 a notification is sent to the radiologist indicating that there are no discrepancies between the processed data and the features in the set of predefined templates.

If there are discrepancies, then at 490 a notification is sent to the radiologist indicating that the radiologist should validate the discrepancies between the processed data and the features in the set of predefined templates and/or augment the report.

FIG. 5 illustrates an example method 500. It is to be appreciated that the ordering of the acts is not limiting. As such, one or more of the acts may occur in a different order, including concurrently with one or more other acts. In addition, one or more of the acts can be omitted and/or one or more other acts can be added.

At 510, it is determined whether an electronic radiology report is available related to the diagnosis of a medical condition of a patient.

If a radiology report is available, then at 520 the radiology report is parsed to extract relevant findings.

At 530, it is determined that the diagnosis in the radiology report is inconclusive.

At 540, it is determined whether another electronic non-radiology report such as a pathology report is available having the information relevant to the radiology report.

If a pathology report is available, then at 550 the pathology report is parsed to extract the relevant information.

At 560, the radiology report is augmented with the relevant information from the pathology report.

At 570, a notification is sent to the radiologist that the radiology report has been augmented with the relevant information from the pathology report and then 510.

In an alternate embodiment, acts 560 and 570 are omitted and a notification is sent to the radiologist indicating the radiologist should validate the relevant information from the pathology report and/or augment the radiology report.

The above may be implemented by way of computer readable instructions, which when executed by a computer processor(s), cause the processor(s) to carry out the described acts. In such a case, the instructions are stored in a computer readable storage medium associated with or otherwise accessible to a relevant computer, such as a dedicated workstation, a home computer, a distributed computing system, and/or other computer. The acts need not be performed concurrently with data acquisition.

It should be noted that the term “comprising” does not exclude other elements or steps and the “a” or “an” does not exclude a plurality. Also elements described in association with different embodiments may be combined. It should also be noted that reference signs in the claims shall not be construed as limiting the scope of the claims.

1. A medical information system (170), comprising:
a validator (140) configured to validate image findings, which are generated based on an image of anatomical structures produced by an imaging apparatus (110), in a first report with at least one of a set of predefined templates or processed data generated based on the set of predefined templates; and
an augmenter (160) configured to augment the first report with information from a second report that includes medical findings.

2. The medical information system (170) of claim 1, the validator (140) further comprising:
a first report analyzer (240) configured to obtain a set of predetermined findings from the first report;
an image processor (220) that processes images based on the set of predefined templates, wherein the images are the images used to generate the first report; and
logic (262) configured to process the first report and the processed data based on one or more rules.

3. The medical information system (170) of claim 2, further comprising a notification component (264) that sends a notification indicative of results of processing the first report and the processed data in accordance with one or more of the rules.

4. The medical information system (170) of claim 3, wherein the notification indicates that there are no discrepancies between findings in the first report and the set of predefined templates.

5. The medical information system (170) of claim 3, wherein the notification indicates that the findings in the first report match the processed data.

6. The medical information system (170) of claim 3, wherein the notification indicates that there is a discrepancy between the findings in the first report and the processed data.

7. The medical information system (170) of claim 3, wherein the logic (262) reconciles a discrepancy between findings not in the first report and in the processed data.

8. The medical information system (170) of claim 1, wherein the first report is a radiology report with medical findings determined from the image.

9. The medical information system (170) of claim 1, the augmenter (160) further comprising:
a second report analyzer (372) to obtain a set of predetermined findings from the second report; and
logic (362) that processes the first report and the second report in accordance with one or more rules.

10. The medical information system (107) of claim 9, further comprising a notification component (364) that sends a notification indicative of results of processing the first report and the second report in accordance with one or more of the rules.

11. The medical information system (170) of claim 9, wherein the logic (362), based on a rule, determines whether findings in the first report are inconclusive, and whether there is a second report having information relevant to the first report, and augments the first report with the information.

12. The medical information system (170) of claim 10, wherein the logic (362), based on a rule, determines whether findings in the first report matches findings in a treatment plan stored in a rule knowledge-base storage medium (365) to evaluate whether the treatment plan is effective, and the notification component (364) sends a notification that the first report has been updated with treatment information.

13. The medical information system (170) of claim 9, wherein the second report is a pathology report with medical findings.

14. A computer readable medium having computer executable instructions stored thereon, which instructions, when executed by a processor, perform a method, the method comprising:
validating findings in a first report with at least one of a set of predefined templates or processed data generated based on the set of predefined templates; and
augmenting the first report with information from a second report generated with medical findings.

15. The computer readable medium of 14, wherein the first report is a radiology report.

16. The computer readable medium of claim 14, wherein the second report is a pathology report.

17. A medical information system (170), comprising:
a validator (140) configured to validate image findings based on an image of anatomical structures generated by an imaging apparatus (110) in a first report with at least one of a set of predefined templates or processed data generated based on the set of predefined templates.

18. The medical information system (170) of claim 17, further comprising:
an augmenter (160) configured to augment the first report with information from a second report that includes medical findings.

19. A medical information system (170), comprising:
an augmenter (160) configured to augment a first report that includes image findings
based on an image of anatomical structures generated by an imaging apparatus (110) with information from a second report that includes medical findings.

20. The medical information system (170) of claim 19, further comprising:
a validator (140) configured to validate the image findings included in the first report with at least one of a set of predefined templates or processed data generated based on the set of predefined templates.

21. A computer readable medium having computer executable instructions stored thereon, which instructions, when executed by a processor, perform a method, the method comprising:
validating findings in a first report with at least one of a set of predefined templates or processed data generated based on the set of predefined templates.

22. The computer readable medium of claim 21, the method further comprising:
augmenting the first report with information from a second report generated with medical findings.

23. A computer readable medium having computer executable instructions stored thereon, which instructions, when executed by a processor, perform a method, the method comprising:
augmenting a first report with information from a second report generated with medical findings.

24. The computer readable medium of claim 23, the method further comprising:
validating findings in the first report with at least one of a set of predefined templates or processed data generated based on the set of predefined templates.

25. A method, comprising:
validating findings in a first report with at least one of a set of predefined templates or processed data generated based on the set of predefined templates; and
augmenting the first report with information from a second report generated with medical findings.

26. A method, comprising:
validating findings in a first report with at least one of a set of predefined templates or processed data generated based on the set of predefined templates.

27. The method of claim 21, further comprising:
augmenting the first report with information from a second report generated with medical findings.

28. A method, comprising:
augmenting a first report with information from a second report generated with medical findings.

29. The method of claim 28, further comprising:
validating findings in the first report with at least one of a set of predefined templates or processed data generated based on the set of predefined templates.
